(19) United States
(12) Patent Application Publication
(10) Pub. No.: US 2015/0292450 A1
(43) Pub. Date: Oct. 15, 2015

(54) POWER AIR BOX

(71) Applicant: Andre Hazarabedian, Northridge, CA (US)

(72) Inventor: Andre Hazarabedian, Northridge, CA (US)

(21) Appl. No.: 14/251,444

(22) Filed: Apr. 11, 2014

(51) Int. Cl. F02M 35/10

(52) U.S. Cl. CPC F02M 35/10091; F02M 35/10085; F02M 35/10327

(57) ABSTRACT

An air intake system for an engine comprising an engine located in an engine compartment having an air intake manifold is provided. An air box is disposed in the engine compartment which includes a first air path and a second air path. The first and the second air paths have pores on one side of the air path for allowing air in and pores on another side of the air path for out letting air. Air outlet from the air box is directly sent to an air filter and is carried by a pipe to an engine throttle body. Preferably, air is received into the air intake device through two air tubes connected to the air box. Preferably, the first air path and the second air path are separated by a divider so that air flow from each of the first and second air paths do not enter the other. Preferably, the air box is situated in front of an engine throttle body. Preferably, air injected out from the device is directly sent to the throttle body. Preferably, the air intake device further comprises a base plate at its bottom that includes numerous pores for maximum air flow.

### BACKGROUND OF THE INVENTION

In an internal combustion engine, engine power is regulated by, inter alia, the amount of air entering the engine, which indirectly controls the charge (fuel+air) burned on each cycle due to the fuel-injector or carburetor maintaining a relatively constant fuel/air ratio. In a motor vehicle the control used by the driver to regulate power is sometimes called the throttle pedal or accelerator¹. ¹ http://en.wikipedia.org/wiki/Throttle

The throttle is typically a butterfly valve. In a fuel-injected engine, the throttle valve is placed on the entrance of the intake manifold, or housed in the throttle body. In a carbureted engine, it is found in the carburetor. When a throttle is wide open, the intake manifold is usually at ambient atmospheric pressure. When the throttle is partially closed, a manifold vacuum develops as the intake drops below ambient pressure². ² See, n.1, Above

In fuel injected engines, the throttle body is the part of the air intake system that controls the amount of air flowing into the engine, in response to driver accelerator pedal input in the main. The throttle body is usually located between the air filter box and the intake manifold, and it is usually attached to, or near, the mass airflow sensor³.

See, n.1,Above

There are various mechanisms and techniques for increasing the power of an engine by regulating the supply and flow of air and/or fuel. However, these mechanisms are often elaborate and expensive, which prevents many car owners from enjoying their benefits.

There is a need for a process and system that addresses the problems of the conventional systems and mechanisms.

### SUMMARY OF THE INVENTION

An air intake mechanism for an engine comprising an engine located in an engine compartment having an air intake manifold is provided. According to one embodiment, an air box is disposed in the engine compartment which includes a first air path and a second air path. The first and the second air paths have pores on one side of the air path for allowing air in and pores on another side of the air path for out letting air. Air outlet from the air box is directly sent to an air filter and is carried by a tube to an engine throttle body (not shown). Preferably,

Preferably, air is received into the air intake device through two air tubes connected to the air box. Preferably, the first air path and the second air path are separated by a divider so that air flow from each of the first and second air paths do not interfere with the other. Preferably, Power Air Box is situated in front of an engine throttle body. Preferably, air injected out from the device is directly sent to the throttle body. Preferably, the air intake device further comprises a base plate at its bottom that includes numerous pores for maximum air flow, which act as a heat sink to keep the air Power Air Box cool.

Advantageously, the inventive air intake device of the present invention allows optimal air flow to the engine to maximize its power at any given RPM and to reduce incoming air temperature efficiently. Power Air Box is preferably constructed primarily out of aluminum. When designing the system inventor found that aluminum has the best heat dissipating capabilities to cost of construction. Since heat reduction is one of the primary goals of the system this material is optimal. The system allows for maximum air flow by increasing the size of the intake tube and how air is routed to the filter assembly.

The filter itself is a cone design which can be cleaned and reused. In one embodiment, filter is constructed from silicon, cotton and steel mesh. The Power Air Box not only takes advantage of the factory cold air intake from the rear lid but also other strategic mechanisms discussed herein that where designed into the system which allows for increased air flow to the engine. Conventional air tubes that direct air to the engine are made from plastic, which, although slow to heat, takes a long time to dissipate the absorbed heat, which, in turn, causes an increase in air temperature and reduces performance.

### BRIEF DESCRIPTION OF THE DRAWINGS

FIG. 1 is a schematic diagram showing the basic design of the inventive Power Air Box in an uncovered condition according to an exemplary embodiment of the present invention.

FIG. 2 is a schematic diagram showing the basic design of the inventive Power Air Box in a covered condition with air tubes for receiving air intake, according to an exemplary embodiment of the present invention.

FIG. 3 is a schematic diagram showing the basic design of the inventive Power Air Box in a covered condition with air tubes for receiving air intake and air filter and air tube for directing outlet air to the engine, according to an exemplary embodiment of the present invention.

FIG. 4 is a plate forming the bottom of the inventive Air Power Box according to an exemplary embodiment of the present invention.

FIG. 5 is a table showing some indicative parameters for an engine operating with the inventive Air Power Box and one with conventional mechanisms.

### DETAILED DESCRIPTION OF THE PREFERRED EMBODIMENT(S)

Details of the present invention will now be discussed by reference to the drawings.

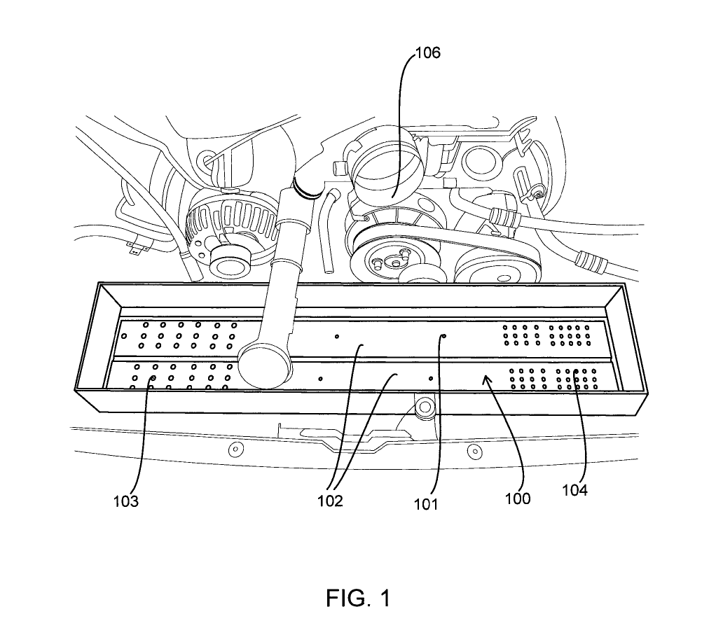

FIG. 1 is a schematic diagram showing the basic design of the inventive Power Air Box in an uncovered condition according to an exemplary embodiment of the present invention. Power Air Box 100 is a box, preferably rectangular in shape that is preferably situated in the front side and adjacent to the car engine 105. Air Paths 101 and 102 receive air and channel the received air to car engine 105 through its throttle body 106 as shown in other drawings. Upon driver pressing on the gas pedal (not shown), air is drawn from the atmosphere into Air Paths 101 and 102, through pores on the left side 103. Drawn air is directed to the other side of the box and is injected out from pores 104 shown on the right side of the Power Air Box. Preferably, air channels are separated by a divider (not shown) located inside the Power Air Box 100 between air paths 101 and 102, designed to keep the air flow in the two air paths from interfering with each other.

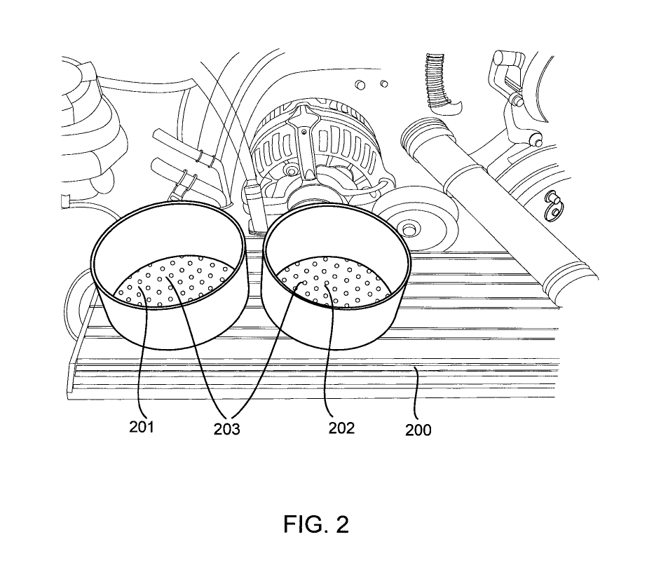

FIG. 2 is a schematic diagram showing the basic design of the inventive Power Air Box in a covered condition with air tubes for receiving air intake, according to an exemplary embodiment of the present invention. Inventive Power Air Box 200 is shown in its covered condition. Air tubes 201 and 202 receive atmospheric air and channel the air into the Power Air Box 200 for processing. In one embodiment, air tubes 201 and 202 are made of aluminum and have a 3 or 4 inch diameter. Air tubes 201 and 202 include mesh bottom surface 203, which, as ordinarily known, is a semi-permeable barrier made of connected strands of metal, fiber, or other suitable materials. The inventors of the Power Air Box recognized that including the mesh in the air tubes 201 and 202, favorably enhances air turbulence and flow and results in more robust air flow from the Power Air Box.

According to one exemplary embodiment, air tube 201 takes in air in a regular manner and directs it toward the air filter (not shown), and the other 203 is situated more directly on top of the pores (not shown) in the Power Air Box and draws the Air at, e.g., 3500-4000 RPM and injects it directly into the Air filter.

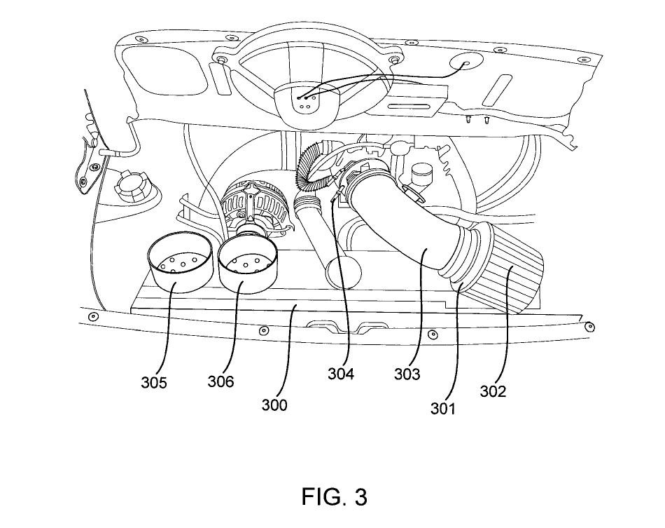

FIG. 3 is a schematic diagram showing the basic design of the inventive Power Air Box in a covered condition with air tubes for receiving air intake and air filter and air tube for directing outlet air to the engine according to an exemplary embodiment of the present invention. Air received by air tubes 305 and 306 is processed by the inventive Power Air Box 300 and directed out of an uncovered portion of the box 301 and aimed directly at air filter 302. Air received by air filter 302 is directed through air tube 303 to the engine throttle body 304. Air filter is covered by a metal mesh covering 307, which acts to cool the air flowing through the air filter and to divert and redirect the air flow.

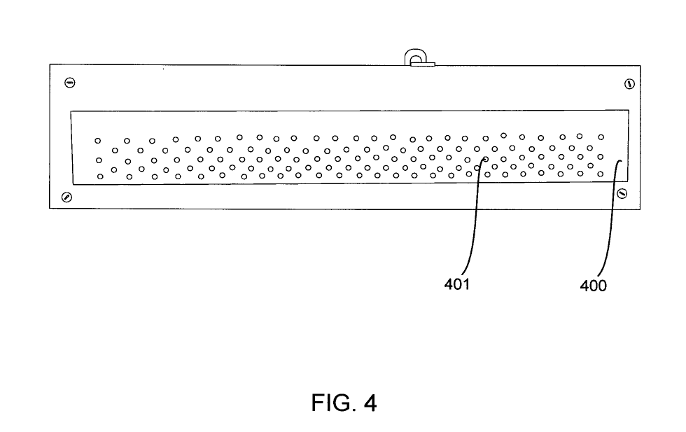

FIG. 4 shows base plate 400 forming the bottom of the inventive Air Power Box according to an exemplary embodiment of the present invention. Base plate 400 includes many pores 401 that help maximize and optimize air flow and act as a sink and help keep the inventive Power Air Box (not shown) cooler. Preferably, base plate is made of aluminum.

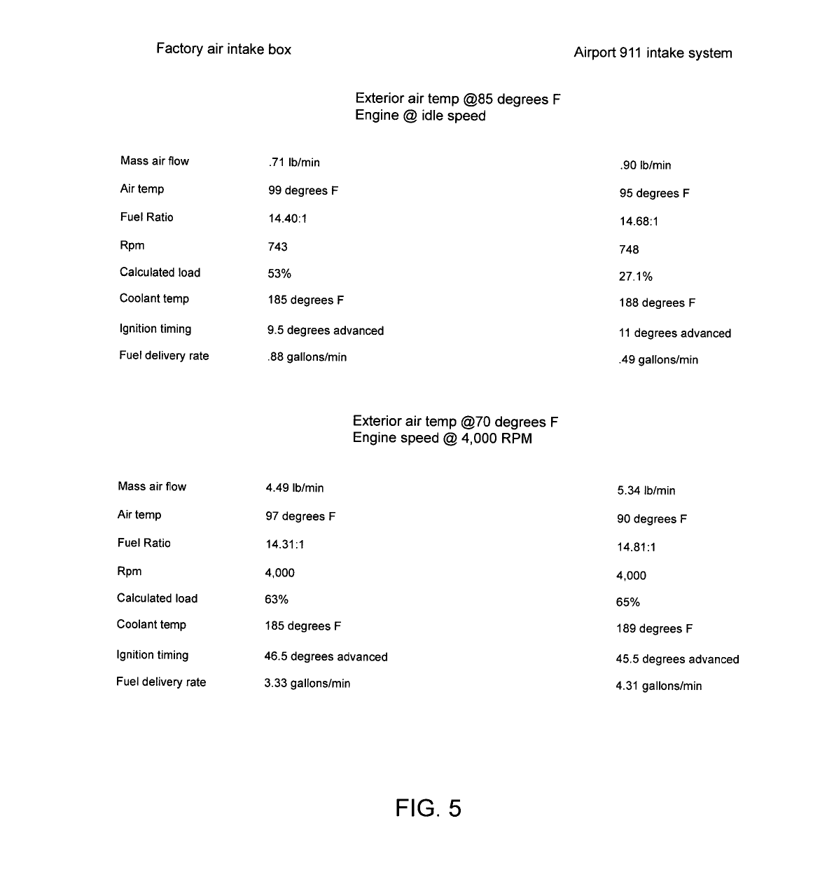

FIG. 5 s a table showing some indicative parameters for an engine operating with the inventive Air Power Box and one with conventional mechanisms. As demonstrated by the comparison of the indicated parameters, the Mass air flow rate shows an increase in both idle and 4,000 rpm conditions. In addition, air temp is at least 5 to 10 degrees cooler than the factory set up. Advantageously, the inventive Power Air Box succeeds in increasing power without exceeding emission requirements. In particular, the Power Air Box does not affect any of the emissions controls on the vehicle but yet allows for an increase in performance and a deeper throttle note that is very unique.

What is claimed is:

1. An air intake system for an engine, comprising:
an engine located in an engine compartment having an air intake manifold;
an air box disposed in the engine compartment, said air box having a first air path and a second air path;
wherein the first and the second air paths have pores on one side of the air path for allowing air in and pores on another side of the air path for out letting air;
wherein air outlet from the air box is directed to an air filter and carried by a pipe to an engine throttle body.

2. The device of claim 1, wherein air is received into the device through two air tubes connected to the air box.

3. The device of claim 1, wherein the first air path and the second air path are separated by a divider so that air flow from each of the first and second air paths do not enter the other.

4. The device of claim 1, wherein the air box is situated in front of an engine throttle body.

5. The device of claim 1, wherein air injected out from the device is directly sent to the throttle body.

6. The device of claim 1 further comprising a base plate at its bottom that includes numerous pores for maximum air flow.
